(19) United States
(12) Patent Application Publication
(10) Pub. No.: US 2009/0172124 A1
(43) Pub. Date: Jul. 2, 2009

(54) Method and Apparatus of Multimedia Data Sharing for a Multimedia Processing Device

(76) Inventor: Mei-Chien Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/194,547

(22) Filed: Aug. 20, 2008

(30) Foreign Application Priority Data
Dec. 27, 2007 (TW) 096150641

(51) Int. Cl. G06F 15/16; G06F 15/173

(52) U.S. Cl. 709/207; 709/223

(57) ABSTRACT

A method for sharing multimedia data in a multimedia processing device includes generating a web address corresponding to a remote multimedia device, and transmitting an indication message according to the web address for notifying the remote multimedia device to receive the web address.

### BACKGROUND OF THE INVENTION

1. Field of the Invention

The present invention relates to a method and apparatus for a multimedia processing device, and more particularly, to a method and apparatus of multimedia data sharing for a multimedia processing device.

2. Description of the Prior Art

With the advancement of technology, using consumer electronic products, such as televisions, computer monitors, digital cameras or mobile phones, to browse digital images has become a part of daily life. At the present time, a digital photo frame, a combination of an LCD (liquid crystal display) panel and a photo frame, is designed for replacing a traditional photo frame.

Generally, a digital photo frame can play multimedia files stored in a memory card. For example, a user puts a CF (Compact Flash) card or a SD (Security Digital) card into a memory interface of a digital photo frame, and then can browse multimedia data stored in the memory card on the digital photo frame. Also, the user can browse multimedia data by making a connection between the digital photo frame and a personal computer via a USB device. Moreover, the digital photo frame may support wireless communication standard, such as WiFi, so that the user can browse multimedia data in a web photo album on the digital photo frame by subscribing to a feed in Really Simple Syndication (RSS) format. RSS format is specified using Extensible Markup Language (XML) for publishing updated website content; therefore, the user simply subscribes to RSS feeds to receive what interested in. Another technology similar to RSS is ATOM.

Please refer to FIG. 1. FIG. 1 is a flowchart of a process 10 for a digital photo frame according to the prior art. The process 10 is utilized for browsing shared multimedia data via a web address. The process 10 comprises the following steps:

Step 100: Start.

Step 102: Select a multimedia data sharing service.

Step 104: Perform a user authentication process.

Step 106: Receive an RSS feed of a web address.

Step 108: Browse shared multimedia data via the web address.

Step 110: End.

According to the process 10, the user can browse shared multimedia data via the web address on the digital photo frame, and the web address, for example, is usually used for a web photo album. Note that, when shared multimedia data via the web address are updated, the user will not be notified, so that the user has to control the digital photo frame to get the RSS feed for browsing updated multimedia data. In addition, a general web photo album is open to all browsers in the internet, and the user of the web photo album cannot share content to specified people.

For a multimedia processing device such as a PC, PDA or mobile phone which includes an input device such as a keyboard, mouse or touch screen, the user can easily share multimedia data to specified people or receive shared multimedia data by others via email function or Multimedia Message Service (MMS). Oppositely, the digital photo frame cannot perform email function or MMS via original simple input interface.

From the above, the prior art digital photo frames and sharing services supported by web photo album service providers no longer satisfy customers' demand. Therefore, it is getting important to develop a new method for the user to browse shared multimedia data by others more conveniently.

### SUMMARY OF THE INVENTION

It is therefore a primary objective of the claimed invention to provide a method and apparatus of multimedia data sharing for a multimedia processing device.

An embodiment of the invention discloses a method for sharing multimedia data in a multimedia processing device comprising generating a web address corresponding to a remote multimedia device, and transmitting an indication message according to the web address, for notifying the remote multimedia device to receive the web address.

An embodiment of the invention further discloses a method for reading multimedia data in a multimedia device comprising receiving a web address according to an indication message, controlling a linking state of the web address, and saving a reading state of the web address.

An embodiment of the invention further discloses a system for sharing multimedia data comprising a first multimedia processing device comprising a web address generator for generating a web address for a second multimedia processing device, and an output unit coupled to the web address generator for outputting the web address and an indication message, wherein the first multimedia processing device outputs the indication message according to the web address for notifying the second multimedia processing device to receive the web address, which is assigned to the second multimedia processing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process for a digital photo frame according to the prior art.

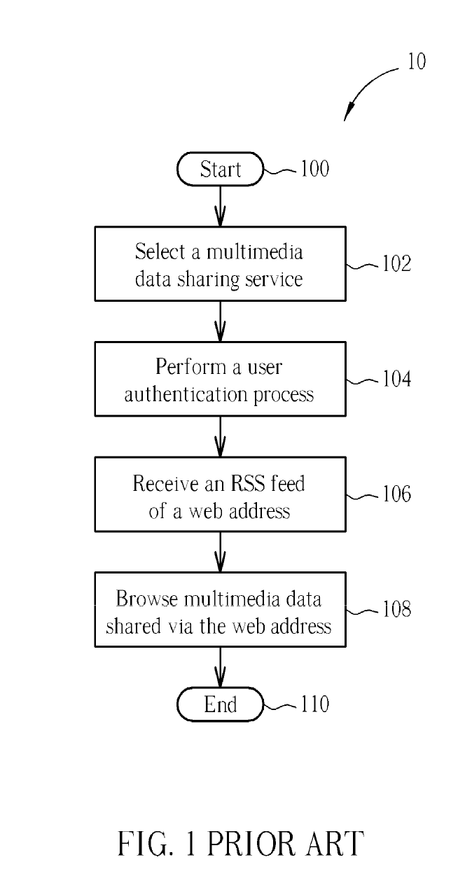

FIG. 2 is a flowchart of a process according to an embodiment of the invention.

FIG. 3 is a schematic diagram of an electronic device according to an embodiment of the invention.

FIG. 4 is a flowchart of a process according to an embodiment of the invention.

FIG. 5 is a schematic diagram of an electronic device according to an embodiment of the invention.

### DETAILED DESCRIPTION

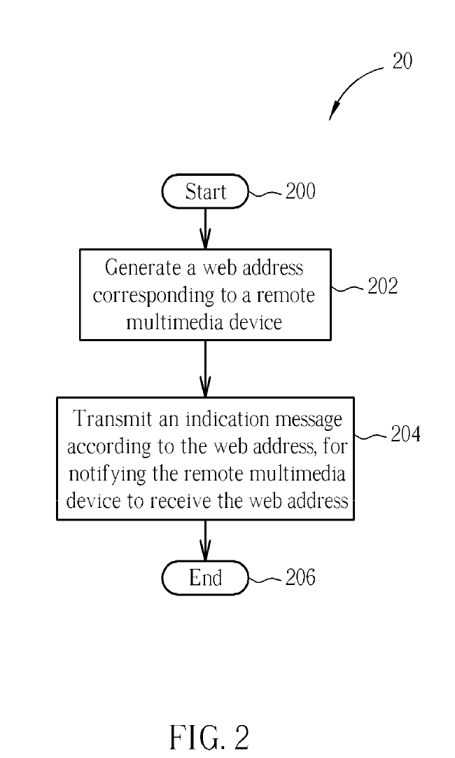

Please refer to FIG. 2. FIG. 2 is a flowchart of a process 20 according to an embodiment of the invention. The process 20 is utilized in a multimedia processing device for sharing multimedia data to a remote multimedia device. The process 20 comprises the following steps:

Step 200: Start.

Step 202: Generate a web address corresponding to a remote multimedia device.

Step 204: Transmit an indication message according to the web address, for notifying the remote multimedia device to receive the web address.

Step 206: End.

According to the process 20, the multimedia processing device generates the web address corresponding to the remote multimedia device, and transmits the indication message to the remote multimedia device according to the web address, for notifying the remote multimedia device to receive the web address. Preferably, the multimedia processing device is a device which is capable to use and manage a web photo album, such as a personal computer or a mobile phone, and the remote multimedia device is a digital photo frame with wireless communication functions. The web address is used for sharing multimedia data and is assigned to the remote multimedia device. In detail, a user of the multimedia processing device can edit a friend list of the user's web photo album, and the multimedia processing device generates a specified identifier for the remote multimedia device inside the web address according to the friend list. As a result, the web address can only be used for the remote multimedia device.

In addition, because the input interface of digital photo frame is simple, the format of the indication message is adopted a Really Simple Syndication (RSS) format for the convenience of browsing messages on the digital photo frame. The indication message can be in other format and is not limited to RSS format. In a word, the user of the multimedia processing device can edit multimedia data specifically shared to a friend using the remote multimedia device, and actively transmit the indication message to the remote multimedia device. As a result, the friend can browse multimedia data more conveniently on the remote multimedia device.

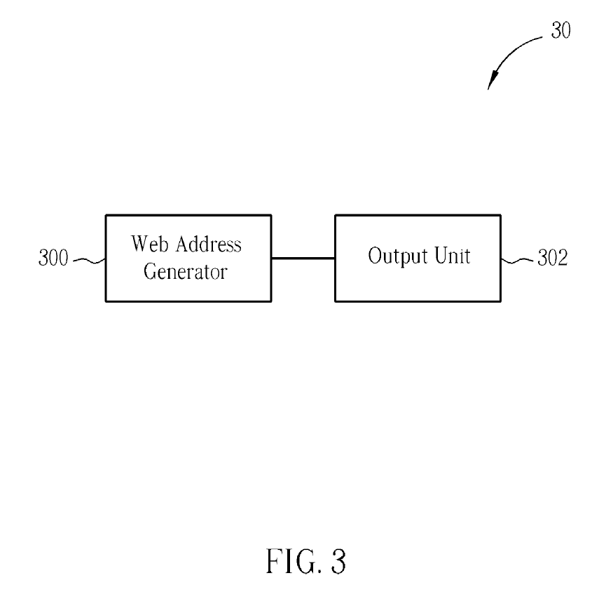

Please refer to FIG. 3 for an implementation of the process 20. FIG. 3 is a schematic diagram of an electronic device 30 according to an embodiment of the invention. The electronic device 30 is utilized in a multimedia processing device for sharing multimedia data. The electronic device 30 comprises a web address generator 300 and an output unit 302 coupled to the web address generator 300. The web address generator 300 is utilized for generating a web address for a remote multimedia device. The output unit 302 is utilized for outputting the web address and an indication message. Preferably, the multimedia processing device is a device which is capable to use and manage a web photo album, such as a personal computer or a mobile phone, and the remote multimedia device is a digital photo frame with wireless communication functions. The web address is used for sharing multimedia data and is assigned to the remote multimedia device. For example, if a user of the multimedia processing device sets a user of the remote multimedia device as a friend, the web address generator 300 can generate a specified identifier inside the web address; therefore, the web address is specifically used by the remote multimedia device. Via the electronic device 30, the user of the multimedia processing device can edit multimedia data specifically shared to a friend using the remote multimedia device, and actively transmit the indication message to the remote multimedia device. As a result, the friend can browse multimedia data more conveniently on the remote multimedia device.

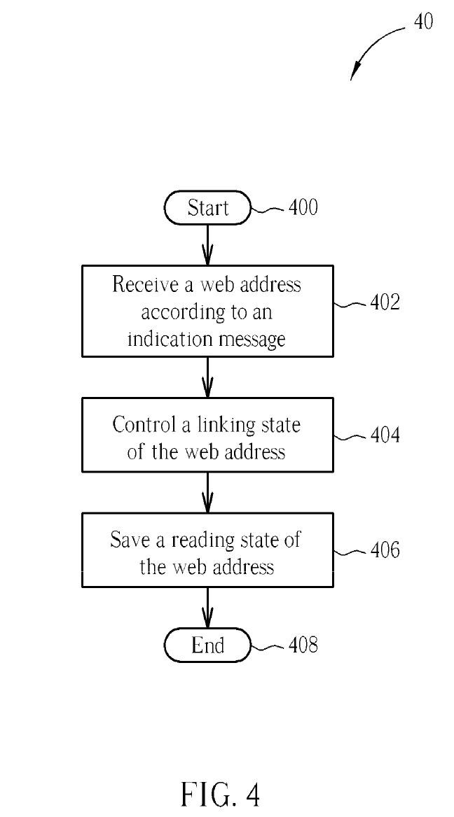

From the above, the multimedia processing device shares multimedia data to the remote multimedia device according to the process 20. On the other hand, please refer to FIG. 4 for a process describing the operation of the remote multimedia device, such as a digital photo frame, after receiving multimedia data from the multimedia processing device. FIG. 4 is a flowchart of a process 40 according to an embodiment of the invention. The process 40 is utilized in a multimedia device for reading multimedia data. The process 40 comprises the following steps:

Step 400: Start.

Step 402: Receive a web address according to an indication message.

Step 404: Control a linking state of the web address.

Step 406: Save a reading state of the web address.

Step 408: End.

According to the process 40, after the multimedia device receives the indication message, the multimedia device receives the web address according to the indication message, controls the linking state of the web address, and saves the reading state of the web address. Preferably, the indication message and the web address are transmitted from the multimedia processing device according to the process 20. Please note that, because the multimedia device may receive a plurality of indication messages, a user of the multimedia device can browse indication messages one by one according to the process 40 and decide to receive the web address corresponding to each indication message or not. In detail, according to the process 40, if the user of the multimedia device decides to receive a web address corresponding to an indication message, the multimedia device links to the web address, loads a plurality of multimedia data corresponding to the web address, and saves the reading state of the web address as an already-read state after loading the plurality of multimedia data. On the contrast, if the user of the multimedia device decides not to receive the web address corresponding to the indication message temporarily, the multimedia device does not link to the web address and then receives another indication message, and at the same time, saves the reading state of the web address as an unread state before receiving the another indication message. Similarly, the multimedia device has to decide to receive the web address corresponding to the another indication message or not. In addition, those unread web addresses are stored in the multimedia device. Therefore, the indication messages corresponding to the unread web addresses will be removed from the plurality of indication messages and not shown again.

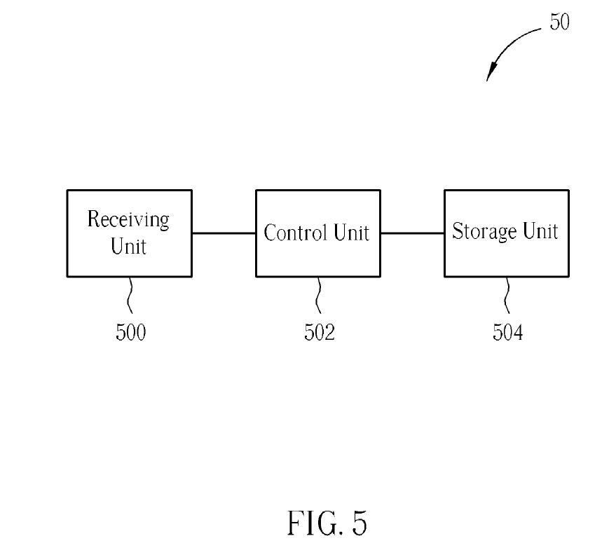

Please refer to FIG. 5 for an implementation of the process 40. FIG. 5 is a schematic diagram of an electronic device 50 according to an embodiment of the invention. The electronic device 50 is utilized in a multimedia device for reading multimedia data. The electronic device 50 comprises a receiving unit 500, a control unit 502 and a storage unit 504. The multimedia device is a digital photo frame with wireless communication functions. The receiving unit 500 is utilized for receiving a web address according to an indication message. The control unit 502 coupled to the receiving unit 500 is utilized for controlling a linking state of the web address. The storage unit 504 coupled to the control unit 502 is utilized for saving a reading state of the web address. For detailed operation of the electronic device 50, please refer to the process 40 and is not given here.

In conclusion, according to the process 20, the multimedia processing device such as a personal computer or a mobile phone can edit multimedia data specifically shared to a friend using the remote multimedia device, and actively transmit the indication message to the remote multimedia device. On the other hand, according to the process 40, the remote multimedia device such as a digital photo frame with wireless communication functions can receive the indication message and the corresponding web address, browse the plurality of indication messages one by one, decide to receive the web address corresponding to the indication message or not, and save the reading state of the web address, so as to browse multimedia data more conveniently. Therefore, the function of the digital photo frame will not be limited by the simple input interface, so as to improve effects of the digital photo frame.

Those skilled in the art will readily observe that numerous modifications and alterations of the device and method may be made while retaining the teachings of the invention.

What is claimed is:

1. A method for sharing multimedia data in a multimedia processing device comprising:
generating a web address corresponding to a remote multimedia device; and
transmitting an indication message according to the web address, for notifying the remote multimedia device to receive the web address.

2. The method of claim 1, wherein the web address is assigned to the remote multimedia device.

3. The method of claim 1, wherein the indication message is a Really Simple Syndication (RSS) format message.

4. A method for reading multimedia data in a multimedia device comprising:
receiving a web address according to an indication message;
controlling a linking state of the web address; and
saving a reading state of the web address.

5. The method of claim 4, wherein the web address is assigned to the multimedia device for receiving a plurality of multimedia data.

6. The method of claim 4, wherein controlling the linking state of the web address is controlling the multimedia device to link to the web address and load a plurality of multimedia data corresponding to the web address.

7. The method of claim 6, wherein saving the reading state of the web address is saving the reading state as an already-read state after the multimedia device loads the plurality of multimedia data.

8. The method of claim 4, wherein controlling the linking state of the web address is controlling the multimedia device not to link to the web address but to receive another indication message.

9. The method of claim 8, wherein saving the reading state of the web address is saving the reading state as an unread state before the multimedia device receives the another indication message.

10. A system for sharing multimedia data comprising:
a first multimedia processing device comprising:
a web address generator for generating a web address for a second multimedia processing device; and
an output unit coupled to the web address generator for outputting the web address and an indication message;
wherein the first multimedia processing device outputs the indication message according to the web address for notifying the second multimedia processing device to receive the web address, which is assigned to the second multimedia processing device.

11. The system of claim 10, wherein the second multimedia processing device comprising:
a receiving unit for receiving the web address according to the indication message;
a control unit coupled to the receiving unit for controlling a linking state of the web address; and
a storage unit coupled to the control unit for saving a reading state of the web address.

12. The system of claim 11, wherein the indication message is a Really Simple Syndication (RSS) format message.

13. The system of claim 11, wherein the web address is used for receiving a plurality of multimedia data.

14. The system of claim 13, wherein the control unit controls the second multimedia processing device to link to the web address and load the plurality of multimedia data corresponding to the web address.

15. The system of claim 14, wherein the storage unit saves the reading state as an already-read state after the second multimedia processing device loads the plurality of multimedia data.

16. The system of claim 15, wherein the indication message is a Really Simple Syndication (RSS) format message.

17. The system of claim 13, wherein the control unit controls the second multimedia processing device not to link to the web address but to receive another indication message.

18. The system of claim 16, wherein the storage unit saves the reading state as an unread state before the second multimedia processing device receives the another indication message.

19. The system of claim 17, wherein the indication message is a Really Simple Syndication (RSS) format message.

20. The system of claim 12, wherein the second multimedia processing device is a digital photo frame.
